(19) United States
(12) Patent Application Publication
(10) Pub. No.: US 2013/0155703 A1
(43) Pub. Date: Jun. 20, 2013

(54) FIXTURE FOR LIGHT GUIDE PLATE

(71) Applicant: SHUN-CHI TSENG, Tu-Cheng (TW)

(72) Inventor: SHUN-CHI TSENG, Tu-Cheng (TW)

(73) Assignee: HON HAI PRECISION INDUSTRY CO., LTD., Tu-Cheng (TW)

(21) Appl. No.: 13/592,599

(22) Filed: Aug. 23, 2012

(30) Foreign Application Priority Data
Dec. 16, 2011 (TW) 100146925

(51) Int. Cl. F21V 21/00

(52) U.S. Cl. 362/433

(57) ABSTRACT

A fixture for loading light guide plates, includes a tray and a plurality of sliding members for supporting the light guide plates. The tray includes a housing and a plurality of supporting members received in the housing. Gaps defined between two adjacent supporting members cooperatively form a plurality of guide channels, and the sliding members are slidably assembled in the tray along the guide channels.

### BACKGROUND

1. Technical Field

The present disclosure relates to fixtures, particularly to a fixture for loading light guide plates.

2. Description of Related Art

A light guide plate produced by insert molding is generally loaded on a tray. The tray includes a rectangular flat board and a plurality of flexible strips made of sponge adhered on the rectangular flat board. A pearl film is coated on a top surface of each flexible strip. The insert-molded light guide plate is loaded on the pearl film of the tray. However, the tray is able to hold only certain sized light guide plates. Other sized light guide plates may deform because the flexible strips for supporting the light guide plate are not the proper size.

Therefore, there is room for improvement in the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the fixtures for light guide plate. Moreover, in the drawings, like reference numerals designate corresponding parts throughout the several views. Wherever possible, the same reference numerals are used throughout the drawings to refer to the same or like elements of an embodiment.

FIG. 1 is an isometric assembled view of an embodiment of a fixture for loading light guide plates.

FIG. 2 is an exploded isometric view of the fixture of FIG. 1.

FIG. 3 is a cross-sectional view of the fixture of FIG. 1 taken along the line III-III.

### DETAILED DESCRIPTION

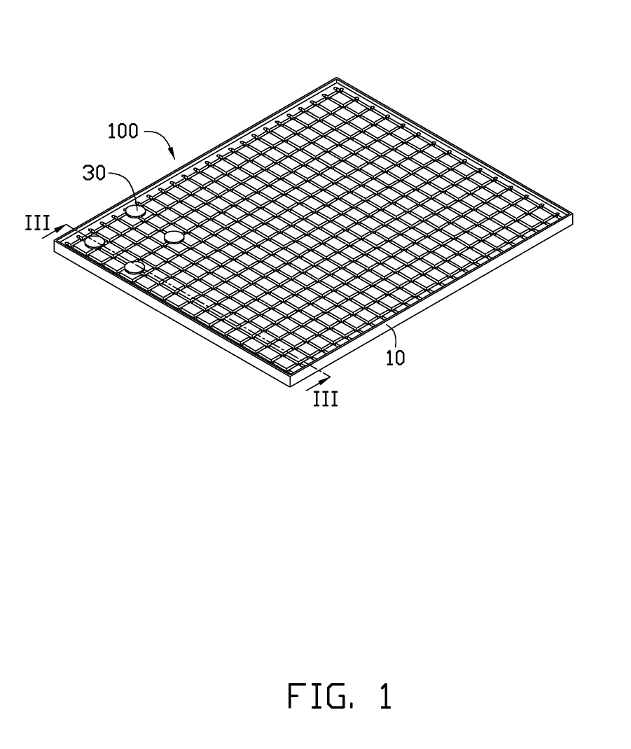

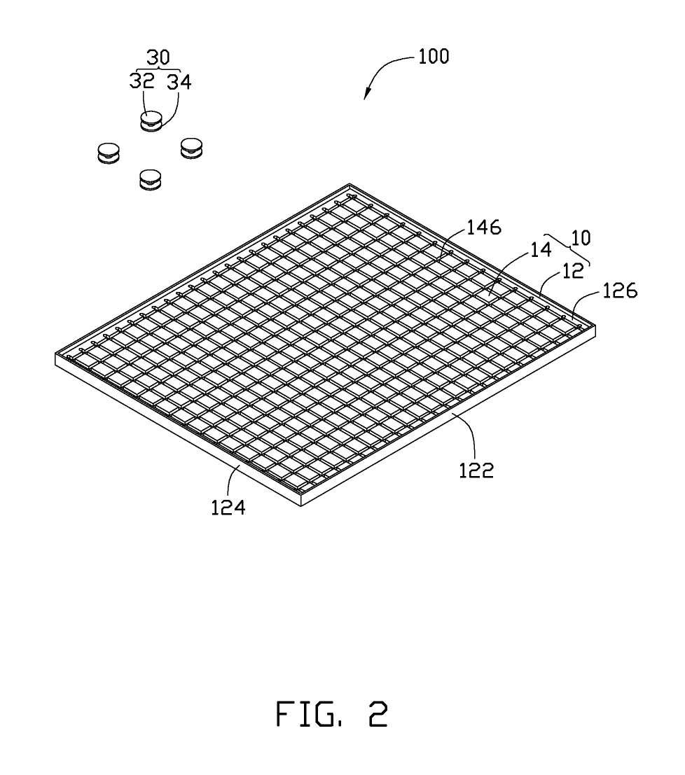

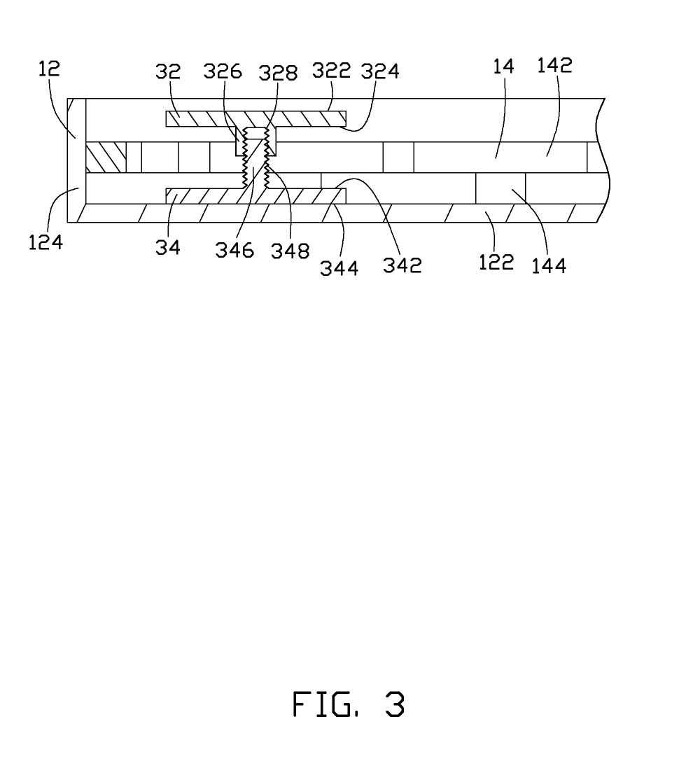

Referring to FIGS. 1 through 3, an embodiment of a fixture 100 for loading light guide plates (not shown) includes a tray 10 and a plurality of sliding members 30 slidably assembled in the tray 10. The sliding members 30 are applied for supporting the light guide plates.

The tray 10 can be a substantially rectangular board made of plastic materials. The tray 10 includes a housing 12 and a plurality of supporting members 14 received in the housing 12. The housing 12 includes a base board 122 and four side walls 124 extending upward from a periphery of the base board 122. The base board 122 and the four side walls 124 cooperatively define a cavity 126 for receiving the supporting members 14, the sliding members 30, and the light guide plates. In one embodiment, the supporting members 14 are made of plastic materials, and each of the supporting members 14 includes a main body 142 and a supporting portion 144 extending from a middle portion of the main body 142. The distal end of the supporting portion 144 is fastened to the base board 122 for support. In the illustrated embodiment, the supporting members 14 are arranged to form a matrix, and each row or each line of the supporting members 14 are substantially parallel. The gaps defined between two adjacent supporting members 14 are substantially the same, and cooperatively form guide channels 146. The sliding members 30 can slide along the guide channels 146.

The sliding member 30 is made of plastic materials, and includes a supporting tray 32 and an adjustable seat 34. The adjustable seat 34 is slidably placed on the base board 122 to support the supporting tray 32. The supporting tray 32 is fastened to the adjustable seat 34 to support a light guide plate. In the illustrated embodiment, the supporting tray 32 is a substantially circular board, and includes a supporting surface 322 and a resisting surface 324 opposite to the supporting surface 322. The supporting tray 32 further includes a tube 326 extending from a middle portion of the resisting surface 324. The tube 326 forms a plurality of internal threads 328 in the inner surface of the tube 326. The shape and the size of the adjustable seat 34 are similar to the shape and the size of the supporting tray 32. The adjustable seat 34 includes a first surface 342 and a second surface 344 opposite to the first surface 342. The adjustable seat 34 further includes a post 346 extending from a middle portion of the first surface 342. The post 346 forms a plurality of external threads 348 on the outer surface of the post 346 corresponding to the internal threads 328. The supporting tray 32 is fastened to the adjustable seat 34 by engaging the external threads 348 of the post 346 in the internal threads 328 of the tube 326. The distance between the supporting tray 32 and the adjustable seat 34 can be adjusted by rotating the supporting tray 32 or the adjustable seat 34. As a result, the height of the sliding member 30 can be adjusted.

In alternative embodiments, the shape of the supporting tray 32 or the adjustable seat 34 can be rectangular, triangular, or oval, for example.

In an alternative embodiment, the tube 326 can be formed on the adjustable seat 34, and the post 346 can be formed on the supporting tray 32, correspondingly.

In assembling the sliding members 30 to the tray 10, each of the adjustable seats 34 are slidably placed between the base board 122 and the supporting members 14. Each of the supporting trays 32 are fastened to one adjustable seat 34 with the tube 326 received in one guide channel 146.

In use, the quantity of the supporting members 30 for a light guide plate is determined according to the size of the light guide plate. The support members 30 are loaded in the tray 10 and can slide along the guide channels 146 to be evenly distributed. The supporting members 30 can be adjusted to the same height or various heights by rotating the supporting trays 32 or the adjustable seats 34. The light guide plate can then be loaded on the supporting members 30 without deformation. In alternative embodiments, the fixture 100 can be used for loading light guide plates of different sizes by changing the quantity of the supporting members 30, or sliding the supporting members 30.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A fixture for loading light guide plates, comprising:
a tray comprising a housing and a plurality of supporting members received in the housing, wherein gaps defined between two adjacent supporting members cooperatively form a plurality of guide channels; and
a plurality of sliding members for supporting the light guide plates slidably assembled in the tray along the guide channels.

2. The fixture of claim 1, wherein the housing comprises a base board and four side walls extending upward from a periphery of the base board, and the base board and the four side walls cooperatively define a cavity for receiving the supporting members and the sliding members.

3. The fixture of claim 2, wherein each of the supporting members comprises a main body and a supporting portion extending from the main body, and a distal end of the supporting portion is fastened to the base board to support the main body.

4. The fixture of claim 3, wherein the supporting members are arranged to form a matrix, each row of the supporting members are substantially parallel, each line of the supporting members are substantially parallel, and sizes of the gaps defined between two adjacent supporting members are substantially the same.

5. The fixture of claim 2, wherein each of the sliding members comprises an adjustable seat and a supporting tray, the adjustable seat is slidably placed on the base board to support the supporting tray, and the supporting tray is fastened to the adjustable seat to support the light guide plate.

6. The fixture of claim 5, wherein the supporting tray comprises a supporting surface, a resisting surface opposite to the supporting surface, and a tube with internal threads extending from the resisting surface, the adjustable seat comprises a first surface, a second surface opposite to the first surface, and a post with external threads extending from the first surface, and the supporting tray is fastened to the adjustable seat by the post engaged in the tube.

7. The fixture of claim 5, wherein the supporting tray comprises a supporting surface, a resisting surface opposite to the supporting surface, and a post with external threads extending from the resisting surface, the adjustable seat comprises a first surface, a second surface opposite to the first surface, and a tube with internal threads extending from the first surface, and the supporting tray is fastened to the adjustable seat by the post engaged in the tube.

8. The fixture of claim 1, wherein the sliding member is made of plastic.
